(19) United States
(12) Patent Application Publication
(10) Pub. No.: US 2011/0162377 A1
(43) Pub. Date: Jul. 7, 2011

(54) TURBOMACHINE NOZZLE

(75) Inventors: Marc Lionel Benjamin, Taylors, SC (US); Bryan Wesley Romig, Simpsonville, SC (US); Derrick Walter Simons, Greer, SC (US); Lucas John Stoia, Taylors, SC (US)

(73) Assignee: GENERAL ELECTRIC COMPANY, Schenectady, NY (US)

(21) Appl. No.: 12/683,102

(22) Filed: Jan. 6, 2010

(51) Int. Cl. F02C 7/22

(52) U.S. Cl. 60/748

(57) ABSTRACT

A turbomachine includes a compressor, a turbine, a combustor operatively coupled to the compressor and the turbine, and an injection nozzle assembly mounted in the combustor. The injection nozzle assembly includes a swirler member provided with a hub portion having an internal surface. The injection nozzle assembly also includes a nozzle section, and a nozzle tip member fluidly coupled to the nozzle section and the swirler member. The nozzle tip member includes a body having a first end section that extends from the nozzle section to a second end section arranged in the hub portion of the swirler member. The nozzle tip member includes an external surface, and a discharge port. At least one of the external surface of the nozzle tip member and the internal surface of the swirler member hub portion is provided with a plurality of grooves.

### BACKGROUND OF THE INVENTION

The subject matter disclosed herein relates to the art of turbomachines and, more particularly, to a turbomachine nozzle.

In general, gas turbomachine engines combust a fuel/air mixture that releases heat energy to form a high temperature gas stream. The high temperature gas stream is channeled to a turbine via a hot gas path. The turbine converts thermal energy from the high temperature gas stream to mechanical energy that rotates a turbine shaft. The turbine may be used in a variety of applications such as providing power to a pump or an electrical generator.

Currently, there is a need to lower turbomachine emissions. One path to lower emissions lies in reducing supplied fuel and operate the turbomachine with a leaner fuel/air mixture. While a lean fuel/air mixture results in lower emissions, fuel nozzle temperatures are higher. That is, by lowering the amount of supplied fuel, the flame is located closer to the nozzle. As such, temperatures on end portions of the nozzle and adjoining swirler hub are increased. The increased temperature on the swirler hub results in cracks and fissures. The cracks/fissures typically develop at an interface between sleeve portions and swirler portions of the nozzle.

### BRIEF DESCRIPTION OF THE INVENTION

According to one aspect of the invention, a turbomachine includes a compressor, a turbine, a combustor operatively coupled to the compressor and the turbine, and an injection nozzle assembly mounted in the combustor. The injection nozzle assembly includes a swirler member provided with a hub portion including an internal surface. The injection nozzle assembly also includes a nozzle section including a first end that extends to a second end, and a nozzle tip member fluidly coupled to the second end of the nozzle section and the swirler member. The nozzle tip member includes a body having a first end section that extends from the nozzle section to a second end section arranged in the hub portion of the swirler member. The nozzle tip member includes an external surface, and a discharge port. At least one of the external surface of the nozzle tip member and the internal surface of the swirler member hub portion is provided with a plurality of grooves. The plurality of grooves are configured and disposed to cool the nozzle tip member.

According to another aspect of the invention, an injection nozzle assembly for a turbomachine includes a swirler member provided with a hub portion having an internal surface, a nozzle section including a first end that extends to a second end, and a nozzle tip member fluidly coupled to the second end of the nozzle section and the swirler member. The nozzle tip member includes a body having first end section that extends from the nozzle section to a second end section arranged in the hub portion of the swirler member. The nozzle tip member includes an external surface, and a discharge port. At least one of the external surface of the nozzle tip member and the internal surface of the swirler member hub portion is provided with a plurality of grooves. The plurality of grooves are configured and disposed to cool the nozzle tip member.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional side view of a turbomachine including a nozzle formed in accordance with exemplary embodiments of the invention . . . .

FIG. 2 is a cross-sectional view of a combustor portion of the turbomachine of FIG. 1;

FIG. 3 is a partial cross-sectional side view of a turbomachine nozzle in accordance with an exemplary embodiment;

FIG. 4 is a perspective view of a nozzle tip portion including a plurality of grooves in accordance with an exemplary embodiment;

FIG. 5 is a detail view of the plurality of grooves of FIG. 4;

FIG. 6 is a perspective view of a nozzle tip portion including a plurality of grooves in accordance with another exemplary embodiment; and

FIG. 7 is a detail view of the plurality of grooves of FIG. 6.

The detailed description explains embodiments of the invention, together with advantages and features, by way of example with reference to the drawings.

### DETAILED DESCRIPTION OF THE INVENTION

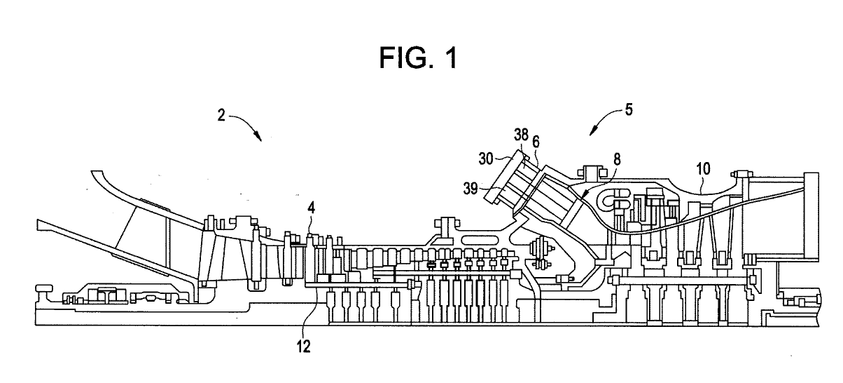

With reference to FIG. 1, a turbomachine constructed in accordance with an exemplary embodiment is indicated generally at 2. Turbomachine 2 includes a compressor 4 and a combustor assembly 5 having at least one combustor 6 provided with a fuel nozzle or injector assembly housing 8. Turbomachine engine 2 also includes a turbine 10 and a common compressor/turbine shaft 12. Notably, the disclosed exemplary embodiments described herein may be incorporated into a variety of turbomachines. Turbomachine 2 shown and described herein is just one exemplary arrangement.

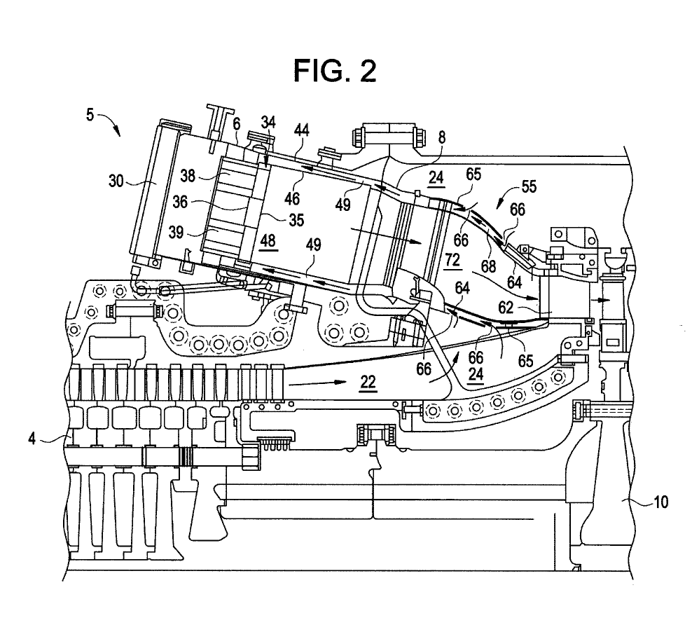

As best shown in FIG. 2 combustor 6 is coupled in flow communication with compressor 4 and turbine 10. Compressor 4 includes a diffuser 22 and a compressor discharge plenum 24 that are coupled in flow communication with each other. Combustor 6 includes an end cover 30 positioned at a first end thereof, and a cap member 34. Cap member 34 includes a first surface 35 and an opposing second surface 36. As will be discussed more fully below, cap member 34, and more specifically, first surface 35 provides structural support to a plurality of fuel or injection nozzle assemblies 38 and 39. Combustor 6 also includes a combustor casing 44 and a combustor liner 46.

As shown, combustor liner 46 is positioned radially inward from combustor casing 44 so as to define a combustion chamber 48. An annular combustion chamber cooling passage 49 is defined between combustor casing 44 and combustor liner 46. A transition piece 55 couples combustor 6 to turbine 10. Transition piece 55 channels combustion gases generated in combustion chamber 48 downstream towards a first stage turbine nozzle 62. Towards that end, transition piece 55 includes an inner wall 64 and an outer wall 65. Outer wall 65 includes a plurality of openings 66 that lead to an annular passage 68 defined between inner wall 64 and outer wall 65. Inner wall 64 defines a guide cavity 72 that extends between combustion chamber 48 and turbine 10.

During operation, air flows through compressor 4 and compressed air is supplied to combustor 6 and, more specifically, to injector assemblies 38 and 39. At the same time, fuel is passed to injector assemblies 38 and 39 to mix with the air and form a combustible mixture. The combustible mixture is channeled to combustion chamber 48 and ignited to form combustion gases. The combustion gases are then channeled to turbine 10. Thermal energy from the combustion gases is converted to mechanical rotational energy that is employed to drive shaft 12.

More specifically, turbine 10 drives compressor 4 via shaft 12 (shown in FIG. 1). As compressor 4 rotates, compressed air is discharged into diffuser 22 as indicated by associated arrows. In the exemplary embodiment, the majority of air discharged from compressor 4 is channeled through compressor discharge plenum 24 towards combustor 6, and the remaining compressed air is channeled for use in cooling engine components. Compressed air within discharge plenum 24 is channeled into transition piece 55 via outer wall openings 66 and into annular passage 68. Air is then channeled from annular passage 68 through annular combustion chamber cooling passage 49 and to injection nozzle assemblies 38 and 39. The fuel and air are mixed forming the combustible mixture that is ignited forming combustion gases within combustion chamber 48. Combustor casing 44 facilitates shielding combustion chamber 48 and its associated combustion processes from the outside environment such as, for example, surrounding turbine components. The combustion gases are channeled from combustion chamber 48 through guide cavity 72 and towards turbine nozzle 62. The hot gases impacting first stage turbine nozzle 62 create a rotational force that ultimately produces work from turbine 2.

At this point it should be understood that the above-described construction is presented for a more complete understanding of exemplary embodiments, which are directed to the structure of injection nozzle assemblies 38 and 39. However, as each injection nozzle assembly 38, 39 is similarly formed, a detail description will follow referencing injection nozzle assembly 38 with an understanding the injection nozzle assembly 39 is similarly formed.

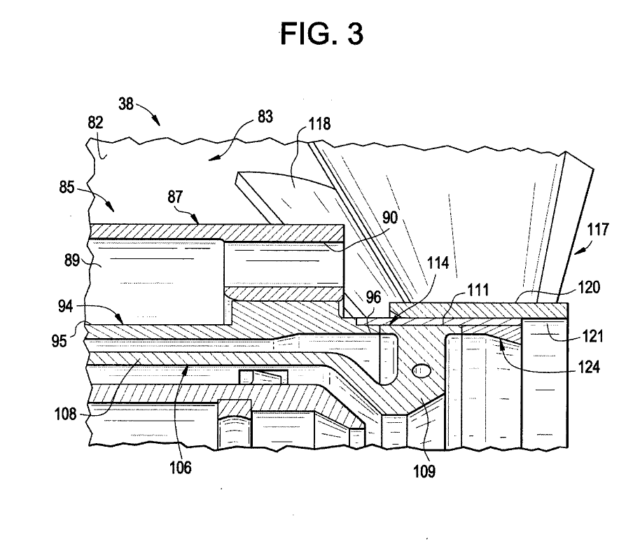

As best shown in FIG. 3, nozzle assembly 38 includes a liner 82 that defines an internal cavity 83. Nozzle assembly 38 further includes a nozzle section 85 that extends through internal cavity 83. Nozzle section 85 includes a transfer/tertiary tip portion 87 that defines a passage 89 having an outlet 90. Nozzle section 85 further includes an inner sleeve portion 94 arranged inboard of tertiary tip portion 87. Inner sleeve portion 94 includes a first end 95 that extends to a second end 96. Nozzle section 85 also includes a pilot tip member 106 arranged inboard of inner sleeve portion 94. Pilot tip member 106 includes a first end portion 108 that extends to a second end portion 109. As shown, second end portion 109 includes an external surface 111 having a plurality of grooves, one of which is indicated at 114. Nozzle assembly 38 is also shown to include a swirler member 117 arranged down stream from nozzle section 85. Swirler member 117 includes a plurality of vanes, one of which is indicated at 118, that extend from a central hub portion 120. Central hub portion 120 includes an internal surface 121 which, as will be discussed more fully below, is fluidly connected to nozzle section 85.

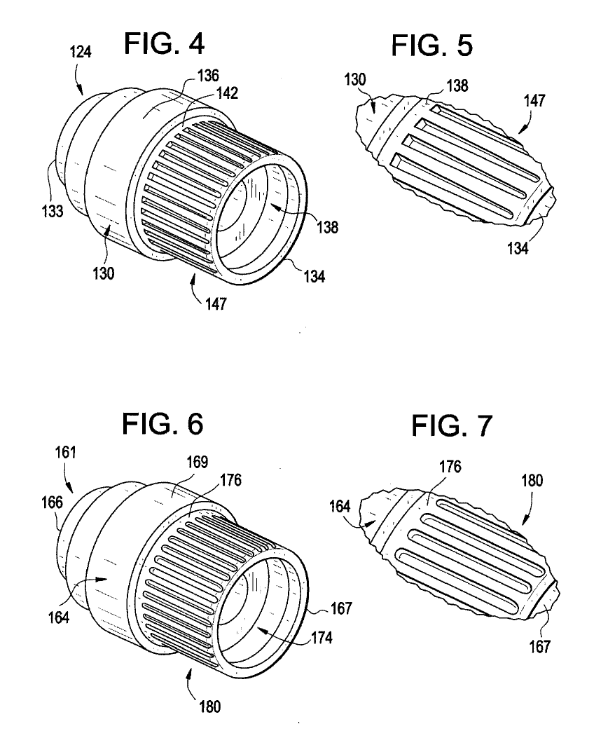

Nozzle section 85 includes a nozzle tip member 124. As best shown in FIG. 4, nozzle tip member 124 includes a body 130 having a first end section 133 that extends to a second end section 134 through an intermediate section 136. Second end section 134 includes a discharge port 138 that is fluidly connected to second end portion 109 of pilot tip member 106. Intermediate section 136 includes an external surface 142 having formed thereon a plurality of grooves 147. Grooves 147 correspond to the plurality of grooves 114 on pilot tip member 106. In the exemplary embodiment shown, grooves 147 including non-circular cross-section. More specifically, and as best shown in FIG. 5, each of the plurality of grooves 147 includes a generally rectangular cross-section. In further accordance with the exemplary embodiment shown, each of the plurality of grooves 147 includes a converging profile. That is, each of the plurality of grooves progressively narrows from first end section 133 toward second end section 134.

With this arrangement, nozzle tip member 124 is arranged within central hub portion 120 of swirler member 117. The plurality of grooves 114 and the plurality of grooves 147 define a plurality of passages that extend between nozzle section 85 and internal surface 121 of central hub portion 120. The plurality of passages provide a conduit or channel through which a fluid flow may pass. The fluid flow lowers temperatures of hub portion 120 to reduce any heat stress to swirler member 117. More specifically, when turbomachine 2 is run in a lean mode, heat stresses tend to develop at hub portion 120. By providing passages between hub portion 120 and nozzle section 85, fluid flows along external surface 111 of pilot tip member 106 and external surface 142 of nozzle tip member 124 to provide a cooling effect. At this point it should be understood that while shown on nozzle tip member 124, the plurality of grooves could also be formed on an internal surface (not separately labeled) of swirler member 117.

Reference will now follow to FIGS. 6 and 7 in describing a nozzle tip member 161 constructed in accordance with another exemplary embodiment. Nozzle tip member 161 includes a body 164 having a first end section 166 that extends to a second end section 167 through an intermediate section 169. Second end section 167 includes a discharge port 174 that is fluidly connected to pilot tip member 106. In a manner similar to that described above, intermediate section 169 includes an external surface 176 having formed thereon a plurality of grooves 180. In accordance with the exemplary embodiment shown, grooves 180 include a generally circular cross-section. More specifically, grooves 180 include a semi-circular cross-section. The semi-circular cross section enhances fluid flow along external surface 176 and avoids introducing excessive geometric stress concentrations into nozzle tip member 161.

At this point, it should be understood that the present exemplary embodiments provide a system for cooling internal portions of a turbomachine nozzle assembly. More specifically, the exemplary embodiments provide cooling passages between nozzle tip portions and an inner hub portion of a swirler member to reduce heat stress. Of course, while the plurality of grooves are shown to include generally rectangular and generally circular cross-sections, other geometries can also be employed without departing from the scope of the claimed embodiments.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a compressor;
a turbine;
a combustor operatively coupled to the compressor and the turbine; and
an injection nozzle assembly mounted in the combustor, the injection nozzle assembly including:
a swirler member including a hub portion including an internal surface;
a nozzle section including a first end that extends to a second end; and
a nozzle tip member fluidly coupled to the second end of the nozzle section and the swirler member, the nozzle tip member including a body having first end section that extends from the nozzle section to a second end section arranged in the hub portion of the swirler member, the nozzle tip member including an external surface, and a discharge port, at least one of the external surface of the nozzle tip member and the internal surface of the swirler member hub portion being provided with a plurality of grooves, the plurality of grooves being configured and disposed to cool the nozzle tip member.

2. The turbomachine according to claim 1, wherein the injection nozzle assembly includes a liner that defines an internal cavity and a tertiary tip portion arranged within the internal cavity spaced from the liner, the nozzle section being arranged within the tertiary tip portion.

3. The turbomachine according to claim 2, wherein the swirler member is arranged downstream from the tertiary tip portion.

4. The turbomachine according to claim 2, further comprising: a pilot tip member including a first end portion that extends to a second end portion having an external surface, the first end portion being arranged within the nozzle section.

5. The turbomachine according to claim 4, wherein the pilot tip member joins the nozzle tip member and the nozzle section.

6. The turbomachine according to claim 5, wherein the pilot tip member includes a plurality of grooves arranged on the external surface, the plurality of grooves corresponding to the plurality of grooves on the one of the external surface of the nozzle tip member and the internal surface of the swirler hub portion.

7. The turbomachine according to claim 1, wherein the plurality of grooves are arranged on the external surface of the nozzle tip member.

8. The turbomachine according to claim 1, wherein the plurality of grooves include a generally circular cross-section.

9. The turbomachine according to claim 1, wherein the plurality of grooves include a non-circular cross-section.

10. The turbomachine according to claim 8, wherein the non-circular cross section comprises a rectangular cross-section.

11. An injection nozzle assembly for a turbomachine, the injection nozzle assembly comprising:
a swirler member including a hub portion including an internal surface;
a nozzle section including a first end that extends to a second end; and
a nozzle tip member fluidly coupled to the second end of the nozzle section and the swirler member, the nozzle tip member including a body having first end section that extends from the nozzle section to a second end section arranged in the hub portion of the swirler member, the nozzle tip member including an external surface, and a discharge port, at least one of the external surface of the nozzle tip member and the internal surface of the swirler member hub portion being provided with a plurality of grooves, the plurality of grooves being configured and disposed to cool the nozzle tip member.

12. The injection nozzle assembly according to claim 11, wherein the injection nozzle assembly includes a liner that defines an internal cavity, and a tertiary tip portion arranged in the internal cavity spaced from the liner, the nozzle section being arranged within the tertiary tip portion.

13. The injection nozzle assembly according to claim 11, further comprising: a pilot tip member including a first end portion that extends to a second end portion having an external surface, the first end portion being arranged within the nozzle section

14. The injection nozzle assembly according to claim 13, wherein the pilot tip member joins the nozzle tip member and the nozzle section.

15. The injection nozzle assembly according to claim 14, wherein the pilot tip member includes a plurality of grooves arranged on the external surface, the plurality of grooves corresponding to the plurality of grooves on the one of the external surface of the nozzle tip member and the internal surface of the swirler hub portion.

16. The injection nozzle assembly according to claim 11, wherein the plurality of grooves are arranged on the external surface of the nozzle tip member.

17. The injection nozzle assembly according to claim 11, wherein the plurality of grooves include a generally circular cross-section.

18. The injection nozzle assembly according to claim 11, wherein the plurality of grooves include a non-circular cross-section.

19. The injection nozzle assembly according to claim 18, wherein the non-circular cross section comprises a rectangular cross-section.

20. The injection nozzle assembly according to claim 11, wherein each of the plurality of grooves includes a converging profile.
